(19) United States
(12) Patent Application Publication
(10) Pub. No.: US 2017/0102267 A1
(43) Pub. Date: Apr. 13, 2017

(54) INFRARED SOURCE

(71) Applicant: THERMO SCIENTIFIC PORTABLE ANALYTICAL INSTRUMENTS INC., Tewksbury, MA (US)

(72) Inventors: Malcolm C. SMITH, Winchester, MA (US); Mark T. DINSMORE, Colorado Springs, CO (US)

(21) Appl. No.: 14/877,050

(22) Filed: Oct. 7, 2015

(51) Int. Cl. G01J 3/10; G01J 3/14; G01J 3/42

(52) U.S. Cl. CPC G01J 3/108; G01J 3/42; G01J 3/14

(57) ABSTRACT

An infrared light source includes a single-crystal ceramic element having at least two electrical contacts disposed thereon, such that the single-crystal ceramic element is stimulated to emit infrared light upon application of an electrical current through the at least two electrical contacts. The infrared light source further includes an evacuated housing enclosing the single-crystal ceramic element, the evacuated housing including an infrared transparent window.

### FIELD OF THE INVENTION

The invention is generally related to an infrared radiation source.

### BACKGROUND

Infrared (IR) light sources are frequently employed in connection with dispersive and non-dispersive infrared spectrometers and gas analyzers. Some IR light sources produce infrared radiation by heating a resistive element to a high temperature (e.g., a temperature of between 1,200 ° C. and 2,000 ° C. for a boron nitride resistive element). For example, U.S. Pat. No. 4,271,363 issued to Anderson on Jun. 2, 1981, the disclosure of which is hereby incorporated by reference in its entirety (however, where anything in the incorporated reference contradicts anything stated in the present application, the present application prevails), discloses a boron nitride resistive element in a hermetically sealed infrared-transparent glass tube with sufficient nitrogen gas inside the tube to prevent dissociation of the boron nitride element. U.S. Pat. No. 7,741,625 B2 issued to Rogne et al. on Jun. 22, 2010, the disclosure of which is hereby incorporated by reference in its entirety (however, where anything in the incorporated reference contradicts anything stated in the present application, the present application prevails), discloses a polysilicon IR source in a hermetically sealed package that can be filled with inert gas or vacuum.

Typical infrared sources for bench-top instruments consist of hot-pressed and sintered ceramic bodies with crimped-on metal electrodes. Such sources typically have a lifetime of between 6 months and 5 years in a controlled laboratory setting with no shocks and limited vibration. The failure modes of these sources include fracture of the ceramic, particularly at pores or grain boundaries that are unavoidably present in the sintered material, and degradation of the mechanical contacts. Other failure modes of IR sources include contamination from ambient particles or gases, fracture of the element due to repeated thermal or mechanical stress, failure of the contact electrodes, or oxidation of the emitter material.

Therefore, there is a need for a robust, long-lived, and efficient infrared source that addresses the deficiencies discussed above.

### SUMMARY

In one embodiment, an infrared light source includes a single-crystal ceramic element having at least two electrical contacts disposed thereon, such that the single-crystal ceramic element is stimulated to emit infrared light upon application of an electrical current through the at least two electrical contacts. The infrared light source further includes an evacuated housing enclosing the single-crystal ceramic element, the evacuated housing including an infrared-transparent window. The single-crystal ceramic element can be a single-crystal silicon carbide element. The at least two electrical contacts can be substantially made of molybdenum. The infrared-transparent window can be one of silicon, germanium, or zinc selenide. In some embodiments, the infrared light source can include at least two low-thermal-conductivity wires connected to the at least two electrical contacts. The at least two low-thermal-conductivity wires can be nickel-chrome wires. In certain embodiments, the evacuated housing can include an infrared reflector. In some embodiments, the infrared light source can further include a getter in the evacuated housing.

In another embodiment, a method of making an infrared light source includes disposing at least two electrical contacts on a single-crystal ceramic element, enclosing the single-crystal ceramic element in a housing that includes an infrared-transparent window, and evacuating the housing. Disposing the at least two electrical contacts can include brazing the contacts on the single-crystal ceramic element, or, alternatively, depositing a metal, such as gold, on the single-crystal ceramic element. The method can further include connecting at least two low-thermal-conductivity wires to the at least two electrical contacts. In some embodiments, the method can further include flowing a current through a getter located within the housing, after evacuating the housing. In other embodiments, the method can further include laser heating the getter located within the housing, after evacuating the housing.

In yet another embodiment, an FTIR spectrometer includes a handheld enclosure having an aperture, a prism mounted in the enclosure so that a surface of the prism is exposed through the aperture, and an electronic display mounted in the enclosure. The FTIR spectrometer further includes an infrared radiation source including a single-crystal ceramic element, and a radiation detector, the infrared radiation source being configured to direct radiation towards the prism, and the detector being configured to detect radiation from the source reflected from the exposed surface of the prism, and an electronic processor contained within the enclosure, the electronic processor being in communication with the detector, wherein the apparatus is configured so that, during operation, the electronic processor determines an identity of a sample placed in contact with the prism and displays the identity of the sample on the electronic display. The FTIR spectrometer can include an evacuated housing enclosing the infrared radiation source, the evacuated housing having an infrared-transparent window. The single-crystal ceramic element of the infrared radiation source can be a single-crystal silicon carbide element. The total mass of the FTIR spectrometer can be less than 2 kg.

The invention has many advantages, such as the ability to withstand shocks that might be encountered by a handheld instrument, a high electrical-to-optical power conversion efficiency that reduces input power requirements and extends battery lifetime, a small IR light emitter area, suitable for forming the limiting optical aperture of an FTIR spectrometer (e.g., a limiting optical aperture smaller than 10 mm² in diameter), and a small package size to reduce space requirements in a handheld instrument.

### BRIEF DESCRIPTION OF THE DRAWINGS

FIG. 1 is a schematic illustration of an infrared light source according to the invention.

FIG. 2 is a schematic illustration of the infrared light source shown in FIG. 1 mounted in a TO-39 header.

FIG. 3 is a perspective view of the infrared light source shown in FIG. 2.

FIG. 4 is a perspective view of an infrared source having an infrared reflector according to the invention.

FIG. 5 is a schematic illustration of a portable FTIR spectrometer including an infrared source according to the invention.

FIG. 6 is a plot of IR power (mW) as a function of input power (mW) in a wavelength range between about 600 cm⁻¹ and about 4,000 cm⁻¹ for a single-crystal silicon carbide infrared light source according to the invention (diamonds), a standard IR source (squares), and a standard IR source scaled for area (triangles).

Like reference numerals refer to corresponding parts throughout the several views of the drawings.

### DETAILED DESCRIPTION OF EMBODIMENTS

In the description of the invention herein, it is understood that a word appearing in the singular encompasses its plural counterpart, and a word appearing in the plural encompasses its singular counterpart, unless implicitly or explicitly understood or stated otherwise. Furthermore, it is understood that for any given component or embodiment described herein, any of the possible candidates or alternatives listed for that component may generally be used individually or in combination with one another, unless implicitly or explicitly understood or stated otherwise. Moreover, it is to be appreciated that the figures, as shown herein, are not necessarily drawn to scale, wherein some of the elements may be drawn merely for clarity of the invention. Also, reference numerals may be repeated among the various figures to show corresponding or analogous elements. Additionally, it will be understood that any list of such candidates or alternatives is merely illustrative, not limiting, unless implicitly or explicitly understood or stated otherwise. In addition, unless otherwise indicated, numbers expressing quantities of ingredients, constituents, reaction conditions and so forth used in the specification and claims are to be understood as being modified by the term “about.”

Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

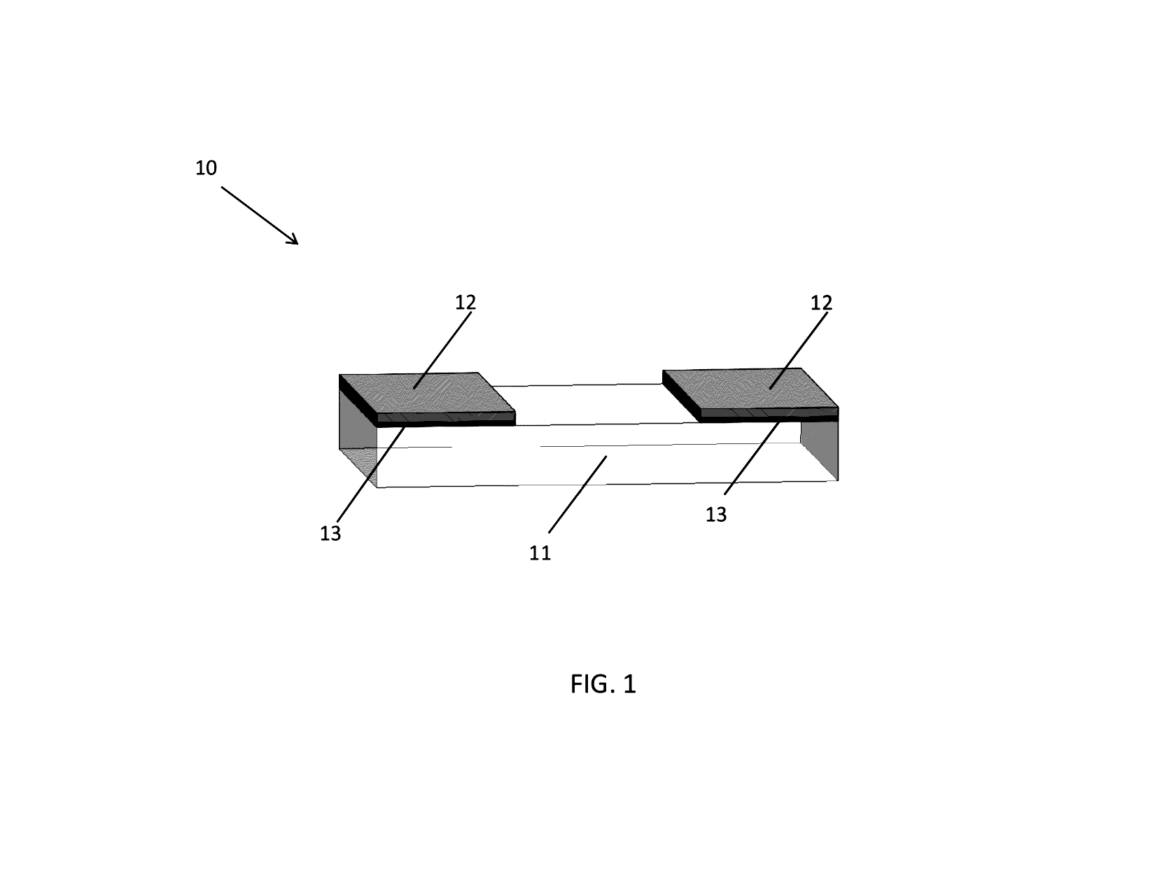

Light sources for Fourier transform infrared (FTIR) spectroscopy applications typically emit light having a wavelength in the range of between about 2.5 microns (μm) and about 15.5 μm, corresponding to a frequency in a range of between about 650 wavenumbers (cm⁻¹) and about 4000 cm⁻¹. In one embodiment, as shown in FIG. 1, an infrared light source 10 includes a single-crystal ceramic element 11 having at least two electrical contacts 12 disposed thereon.

A single-crystal ceramic element, such as the single-crystal ceramic element 11, lacks the pores and grain boundaries typically present in sintered material, forming a monolithic block which is less likely to fracture under repeated thermal and mechanical stresses. A variety of single-crystal ceramic materials can be used for the single-crystal ceramic element 11, such as, for example, single-crystal silicon carbide or single-crystal silicon nitride. When heated to a temperature in a range of between about 600° C. and about 900° C., single-crystal silicon carbide has a large emissivity (equal to or greater than 0.9) in the 2.5 μm to 15.5 μm spectral region. Silicon carbide also has a high melting point (2,730° C.) and high strength, producing a robust IR emitter. Single-crystal silicon carbide is typically available from Norstel (Norrkiping, Sweden) and Biotain Crystal Materials (Xiamen City, China) as a semiconductor substrate having a suitable thickness, such as about 0.3 mm, with a dopant (e.g., nitrogen) producing suitable resistivity, such as a resistivity in a range of between 0.02 ohm-cm and 0.1 ohm-cm, for use as an IR emitter.

The electrical contacts 12 need to have a suitable electrical conductivity, and a high melting point. In one embodiment, the electrical contacts 12 also need to be readily brazed on to the ceramic element 11, and have a coefficient of thermal expansion (CTE) that is closely matched to the CTE of the single-crystal ceramic element 11. For silicon carbide, which has a CTE of about 4.0 ppm/° C., suitable materials for brazed electrical contacts 12 include molybdenum (Mo) and tungsten (W). Molybdenum has a CTE of 4.8 ppm/° C. and a melting point of 2,623° C. As an alternative to brazing, electrical contacts 12 can be made by metal (e.g., gold or aluminum) deposition onto the single-crystal ceramic element 11.

Turning back to FIG. 1, in one embodiment, the electrical contacts 12 are brazed onto the single-crystal ceramic element 11 using a braze material 13. Examples of suitable braze materials 13 known to those skilled in the art generally as braze materials include a copper active braze material (Cu-ABA) containing a small amount of titanium. During operation, the single-crystal ceramic element 11 is stimulated by an electrical current conducted through the two electrical contacts 12 to emit infrared light.

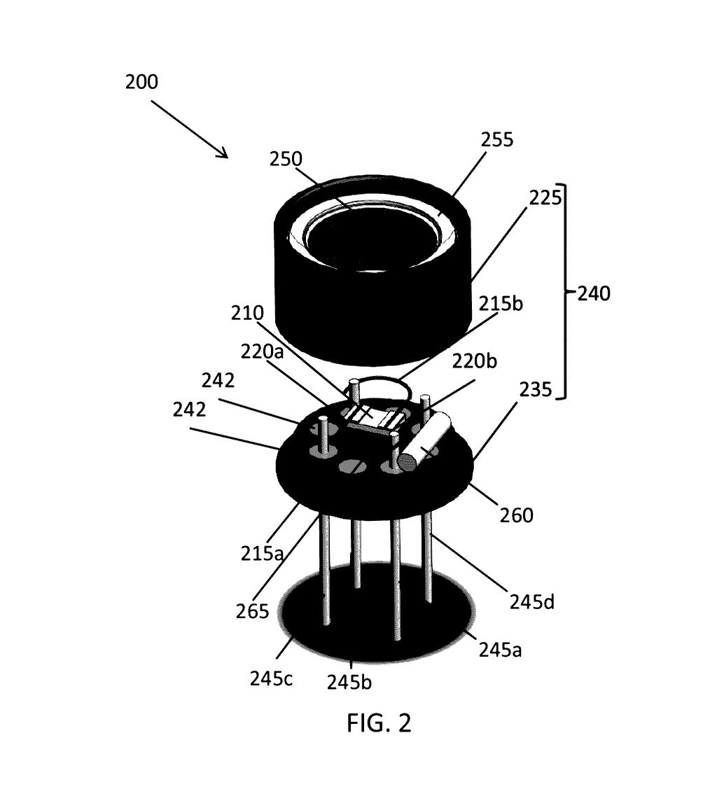

Turning to FIG. 2, infrared light source 200 includes a housing 240 enclosing the single-crystal ceramic element 210. In the embodiment shown in FIG. 2, the single-crystal ceramic element 210 is a single-crystal silicon carbide element. The length of the single-crystal silicon carbide element is in a range of between 0.25 mm and 25 mm (e.g., 0.30 mm, 0.35 mm, 0.40 mm, 0.50 mm, 0.40 mm, 1.0 mm, 1.5 mm, 2.0 mm, 2.5 mm, 3.0 mm, 3.5 mm, 4.0 mm, 4.5 mm, 5.0 mm, 6.0 mm, 7.0 mm, 8.0 mm, 9.0 mm, 10.0 mm, 15.0 mm, or 20.0 mm), such as a range of between 1.25 mm and 5 mm. The width of the single-crystal silicon carbide element is in a range of between 0.15 mm and 15 mm (e.g., 0.20 mm, 0.25 mm, 0.30 mm, 0.35 mm, 0.40 mm, 0.45 mm, 0.50 mm, 1.0 mm, 1.5 mm, 2.0 mm, 2.5 mm, 3.0 mm, 3.5 mm, 4.0 mm, 4.5 mm, 5.0 mm, 6.0 mm, 7.0 mm, 8.0 mm, 9.0 mm, or 10.0 mm), such as a range of between 0.75 mm and 3 mm. The thickness of the single-crystal silicon carbide element is in a range of between 0.03 mm and 3.5 mm (e.g., 0.05 mm, 0.06 mm, 0.07 mm, 0.08 mm, 0.09 mm, 0.1 mm, 0.2 mm, 0.3, 0.4 mm, 0.5 mm, 1.0 mm, 1.5 mm, 2.0 mm, 2.5 mm, or 3.0 mm), such as a range of between 0.15 mm and 0.5 mm. In one embodiment, the dimensions of the single-crystal silicon carbide element 210 are: 2.5 mm long, 1.6 mm wide, and 0.33 mm thick. The housing 240 is preferably evacuated, as vacuum provides the best thermal insulation for the single-crystal ceramic element 210. Several standard electronic packages (e.g., TO-8, TO-39, TO-46) are suitable for the housing 240. Suitable electronic packages are available from, for example, Analog Devices (Norwood, Mass.), Schott North America (Elmsford, N.Y.), or TEC Microsystems (Berlin, Germany). In the case of a TO-39 electronic package shown in FIG. 2, the housing 240 is made of two parts, a cap 225 and a header 235. The header 235 and the cap 225 are made of a low CTE metal, such as ASTM F-15 (Kovar™), that is suitable for laser welding the cap 225 onto the header 235. The header 235 includes four posts or pins 245a, 245b, 245c, and 245d, that are electrically insulated from the header 235. The insulation 242 is typically a low-melting-point glass frit, commonly employed in vacuum feed-through connections. The glass frit has a well-matched CTE to the Kovar™ of the header 235. The header 235 also optionally includes an evacuation port 265 in the center of the header 235. The cap 225 includes a window 250 that is attached to the cap 225 by a hermetic seal 255. The window 250 is made of an infrared transparent material, such as a silicon (Si), germanium (Ge), or zinc selenide (ZnSe), or any other material that is transparent to infrared light. The hermetic seal 255 is formed by first metallizing the window 250 at the solder joint area, and then soldering the window 250 to the cap 225 using a suitable solder, such as a silver-tin solder, under an inert atmosphere. Alternatively, the window 250 is soldered into the cap 225 using a silver-tin preform. The window 250 is preferably anti-reflection coated on at least one side of the window 250, and more preferably anti-reflection coated on both sides of the window 250, to increase the amount of infrared light transmitted through the window. Optionally, the window 250 can be a lens (not shown) having a focal length suitable for collimating the light exiting the infrared light source 200.

As also shown in FIG. 2, electrical contact to single-crystal ceramic element 210 is made by two electrical contacts 220a and 220b, that are made of molybdenum or tungsten as described above, and brazed on the single-crystal ceramic element 210 using a braze material such as Cu-ABA (see FIG. 1). The length of the electrical contacts 220a and 220b is in a range of between 0.05 mm and 5 mm (e.g., 0.10 mm, 0.15 mm, 0.20 mm, 0.25 mm, 0.30 mm, 0.35 mm, 0.40 mm, 0.45 mm, 0.50 mm, 1.0 mm, 1.5 mm, 2.0 mm, 2.5 mm, 3.0 mm, 3.5 mm, 4.0 mm, or 4.5 mm), such as in a range of between 0.25 mm and 1 mm The width of the electrical contacts 220a and 220b is in a range of between 0.15 mm and 15 mm (e.g., 0.20 mm, 0.25 mm, 0.30 mm, 0.35 mm, 0.40 mm, 0.45 mm, 0.50 mm, 1.0 mm, 1.5 mm, 2.0 mm, 2.5 mm, 3.0 mm, 3.5 mm, 4.0 mm, 4.5 mm, 5.0 mm, 6.0 mm, 7.0 mm, 8.0 mm, 9.0 mm, 10.0 mm, 11.0 mm, 12.0 mm, 13.0 mm, or 14.0 mm), such as a range of between 0.75 mm and 3 mm. The thickness of the electrical contacts 220a and 220b is in a range of between 0.025 mm and 2.5 mm (e.g., 0.030 mm, 0.035 mm, 0.040 mm, 0.045 mm, 0.050 mm, 0.10 mm, 0.150 mm, 0.20 mm, 0.25 mm, 0.30 mm, 0.35 mm, 0.40 mm, 0.45 mm, 0.50 mm, 1.0 mm, 1.5 mm, or 2.0 mm), such as a range of between 0.125 mm and 0.5 mm. In one embodiment, the dimensions of the electrical contacts 220a and 220b are 1.5 mm wide, 0.5 mm long, and 0.25 mm thick. Two J-shaped low-thermal-conductivity wires 215a and 215b are either brazed to the two electrical contacts 220a and 220b, respectively, using a braze material with a liquidus temperature just below the liquidus temperature of Cu-ABA (1,300 K), or laser welded. As shown in FIG. 2, the long arm of the J-shape of the wires 215a and 215b runs parallel to the width of the contacts 220a and 220b. The other end of the wires 215a and 215b is then either soldered (e.g., using a lead-tin or silver-tin solder) or laser welded to header posts 245a and 245b, respectively. The wires 215a and 215b are preferably made of a low-thermal-conductivity material, that is, a material having a thermal conductivity less than 50 W/(m. K), such as, for example, nickel-chrome (NiCr) alloy, having a thermal conductivity of 11 W/(m. K), and a diameter of 0.005″ (127 μm), that provides sufficient electrical conductivity, fairly good thermal insulation, and adequate mechanical support. In some embodiments, additional mechanical support is provided by mounting the single-crystal ceramic element onto a thermally insulating base (not shown).

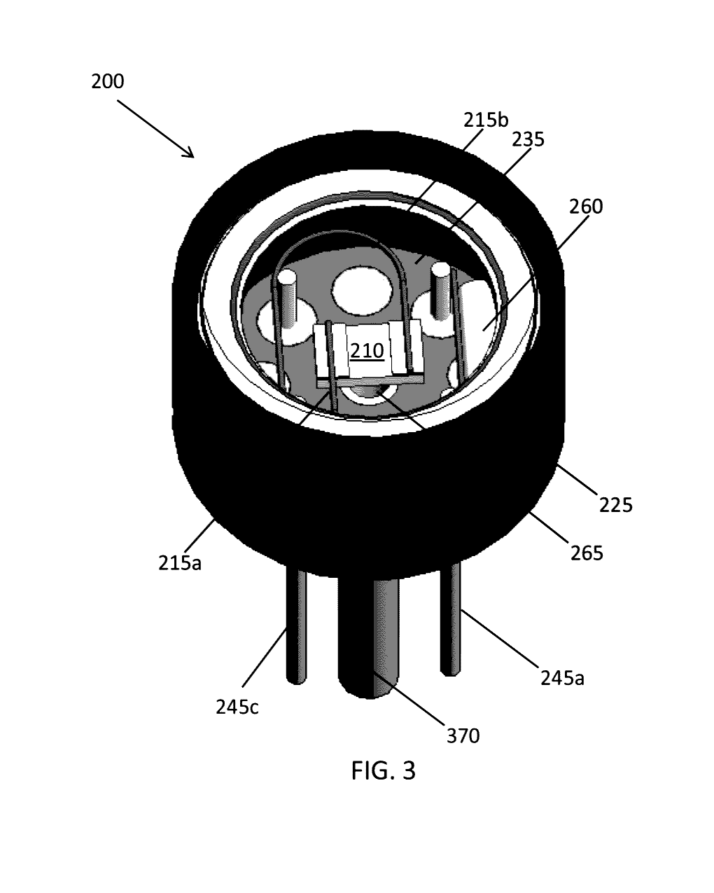

In some embodiments, as also shown in FIG. 2, the infrared light source 200 can further include a getter 260 in the evacuated housing 240, available from SAES Getters (Colorado Springs, CO), e.g., St 171 or St 172 sintered porous getters. Turning to FIG. 3, the header 235 can have an external tube 370 attached by laser welding to the evacuation port 265 at the center of the header 235. The getter 260 can be attached between an unused pin, such as 245d, and any other pin, such as 245a, as shown in FIG. 3. The housing 240 is baked, such as by heating to a temperature of about 150° C., and evacuated through the tube 370 to an absolute pressure of less than about 50 mTorr. The getter 260 is then activated while still under vacuum by flowing a current through the getter 260 or by laser heating the getter 260, and then the tube 370 is pinched off and reinforced with solder that can be applied with a soldering iron.

An alternative to the evacuation and sealing process described above is to use a vacuum compatible sealer, in which case the tube 370 is not needed. In this case, the header 235 and cap 225 are assembled in a sealed chamber, the chamber is evacuated, and the seal between the header 235 and the cap 225 is made by electrically heating the seal region.

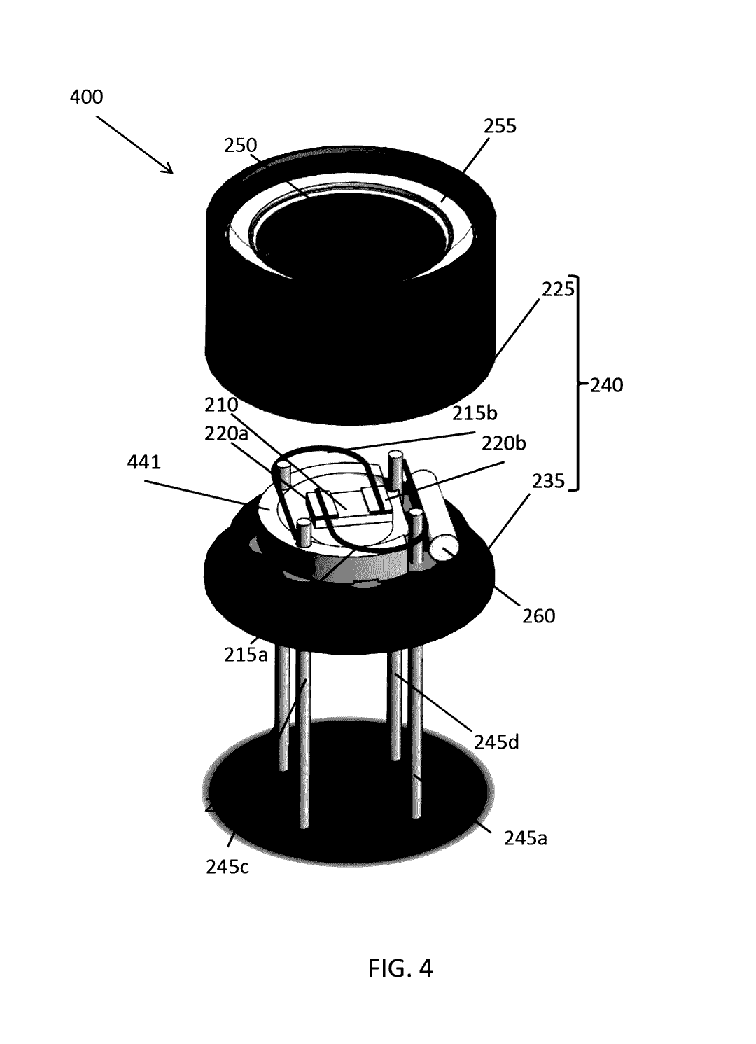

In another embodiment, as shown in FIG. 4, the evacuated housing of an infrared light source 400 includes an infrared reflector 441, placed between the single-crystal ceramic element 210 and the header 235, to reflect infrared radiation back onto the ceramic element 210, and thereby further heat the ceramic element 210, increasing the temperature of the ceramic element 210, and increasing the efficiency of the infrared light source 200. In some embodiments, the infrared reflector is a flat piece of polished metal (e.g., aluminum) attached to the header (not shown). In one embodiment, as shown in FIG. 4, the infrared reflector 441 is a spherical or curved mirror that reflects infrared radiation back onto the ceramic element 210.

As described in U.S. Pat. No. 7,928,391 B2 issued to Azimi et al., on Apr. 19, 2011, the disclosure of which is hereby incorporated by reference in its entirety (however, where anything in the incorporated reference contradicts anything stated in the present application, the present application prevails), many applications exist for portable measurement devices, including field identification of unknown substances by law enforcement and security personnel, detection of prohibited substances at airports and in other secure and/or public locations, and identification pharmaceutical agents, industrial chemicals, explosives, energetic materials, and other agents. To be useful in a variety of situations, it can be advantageous for portable measurement devices to have a handheld form factor, to have a long operational life, a low power consumption, and to rapidly provide accurate results.

In certain embodiments, the measurement devices and methods disclosed herein provide for contact between a sample of interest and the measurement device via a prism positioned in a protrusion of the measurement device's enclosure. The prism, which can be formed from a relatively hard material such as diamond, operates by ensuring that non-absorbed incident radiation is directed to a detector after undergoing total internal reflection within the prism. As a result, reflected radiation is coupled with high efficiency to the detector, ensuring sensitive operation of the measurement devices.

Samples of interest can be identified based on the reflected radiation that is measured by the detector. The reflected radiation can be used to derive infrared absorption information corresponding to the sample, and the sample can be identified by comparing the infrared absorption information to reference information for the sample that is stored in the measurement device. In addition to the identity of the sample, the measurement device can provide one or more metrics (e.g., numerical results) that indicate how closely the infrared absorption information matches the reference information. Further, the measurement device can compare the identity of the sample of interest to a list of prohibited substances—also stored within the measurement device—to determine whether particular precautions should be taken in handling the substance, and whether additional actions by security personnel, for example, are warranted. A wide variety of different samples can be interrogated, including solids, liquids, gels, powders, and various mixtures of two or more substances.

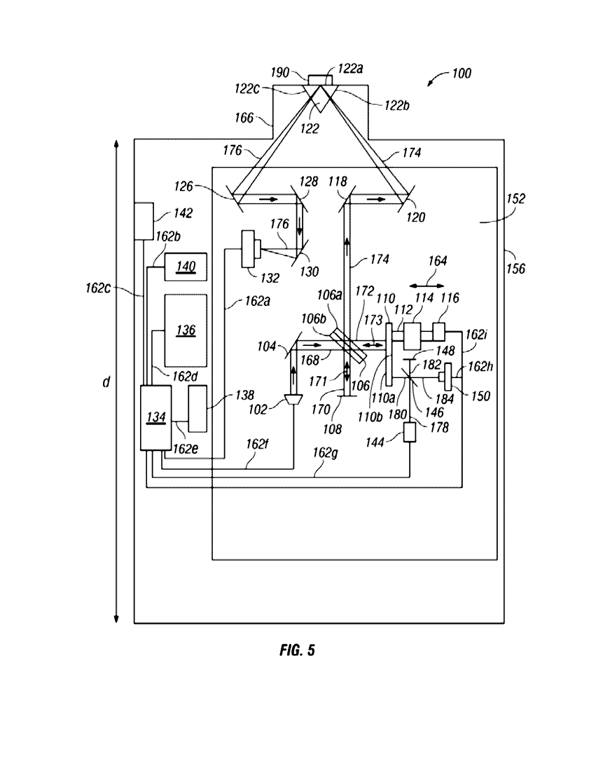

FIG. 5 shows a schematic diagram of a measurement device 100. Device 100 includes an optical assembly mounted on an assembly support 152 that is fixed within an enclosure 156. The optical assembly includes: radiation sources 102 and 144; mirrors 104, 108, 110, 148, 118, 120, 126, 128, and 130; beamsplitters 106 and 146; detectors 132 and 150; and prism 122. Device 100 also includes a shaft 112, a bushing 114, and an actuator 116 coupled to mirror 110, and an electronic processor 134, an electronic display 136 (e.g., including a flat panel display element such as a liquid crystal display element, an organic light-emitting diode display element, an electrophoretic display element, or another type of display element), an input device 138, a storage unit 140, and a communication interface 142. Electronic processor 134 is in electrical communication with detector 132, storage unit 140, communication interface 142, display 136, input device 138, radiation sources 102 and 144, detector 150, and actuator 116, respectively, via communication lines 162a-i.

Measurement device 100 is configured for use as a Fourier transform infrared (FTIR) spectrometer. During operation, radiation 168 is generated by radiation source 102 under the control of processor 134. In one embodiment, radiation source 102 is an infrared light source that includes a single-crystal ceramic element as described above. Radiation 168 is directed by mirror 104 to be incident on beamsplitter 106, which is formed from a beamsplitting optical element 106a and a phase compensating plate 106b, and which divides radiation 168 into two beams. A first beam 170 reflects from a surface of beamsplitter 106, propagates along a beam path which is parallel to arrow 171, and is incident on fixed mirror 108. Fixed mirror 108 reflects first beam 170 so that first beam 170 propagates along the same beam path, but in an opposite direction (e.g., towards beamsplitter 106).

A second beam 172 is transmitted through beamsplitter 106 and propagates along a beam path which is parallel to arrow 173. Second beam 172 is incident on a first surface 110a of movable minor 110. Movable mirror 110 reflects second beam 172 so that beam 172 propagates along the same beam path, but in an opposite direction (e.g., towards beamsplitter 106).

First and second beams 170 and 172 are combined by beamsplitter 106, which spatially overlaps the beams to form incident radiation beam 174. Mirrors 118 and 120 direct incident radiation beam 174 to enter prism 122 through prism surface 122b. Once inside prism 122, radiation beam 174 is incident on surface 122a of the prism 122. Surface 122a of prism 122 is positioned such that it contacts a sample of interest 190. When radiation beam 174 is incident on surface 122a, a portion of the radiation is coupled into sample 190 through surface 122a. Typically, for example, sample 190 absorbs a portion of the radiation in radiation beam 174.

Radiation beam 174 undergoes attenuated total internal reflection (ATR) from surface 122a of prism 122 as reflected beam 176. Reflected beam 176 includes, for example, the portion of incident radiation beam 174 that is not absorbed by sample 190. Reflected beam 176 leaves prism 122 through surface 122c, and is directed by minors 126, 128, and 130 to be incident on detector 132. Under the control of processor 134, detector 132 measures one or more properties of the reflected radiation in reflected beam 176. For example, detector 132 can determine absorption information about sample 190 based on measurements of reflected beam 176. While the operation of an ATR FTIR spectrometer is described above, the infrared light sources described herein are suitable for use in any FTIR spectrometer.

### EXEMPLIFICATION

Several examples of the IR light source described above were made, with results comparing favorably to a commonly used commercial IR source available from Intex (Tucson, AZ) obtained under part number INTX 17-900, which is believed to be made of an amorphous deposited carbon with a silicon nitride protective layer. Silicon carbide single-crystal material was diced up into 1.6×2.5 mm² pieces that were 0.33 mm thick. Each element had molybdenum (Mo) pieces having an area of 1.5×0.5 mm² and a thickness of 0.25 mm attached by brazing. The braze compound was copper ABA. The braze process was carried out at 1,100° C. for 2-3 minutes in vacuum in an induction brazing setup. Following brazing, NiCr wires were laser welded between the TO-8 header pins and the Mo pads. A case was prepared by first metalizing a ZnSe window with a ring of Ti/Pt/Au. The window was then soldered with 3.5% AgSn solder into a Kovar ™ TO-8 can with a suitable opening machined for the window. The can was then hermetically sealed to the header with a laser welding process. The housing was simultaneously baked at 150° C. and evacuated through a tube in the header. The getter was then fired while still under vacuum. The tube was then pinched off and reinforced with solder applied with a soldering iron. The element was mounted such that the contact areas were facing away from the window.

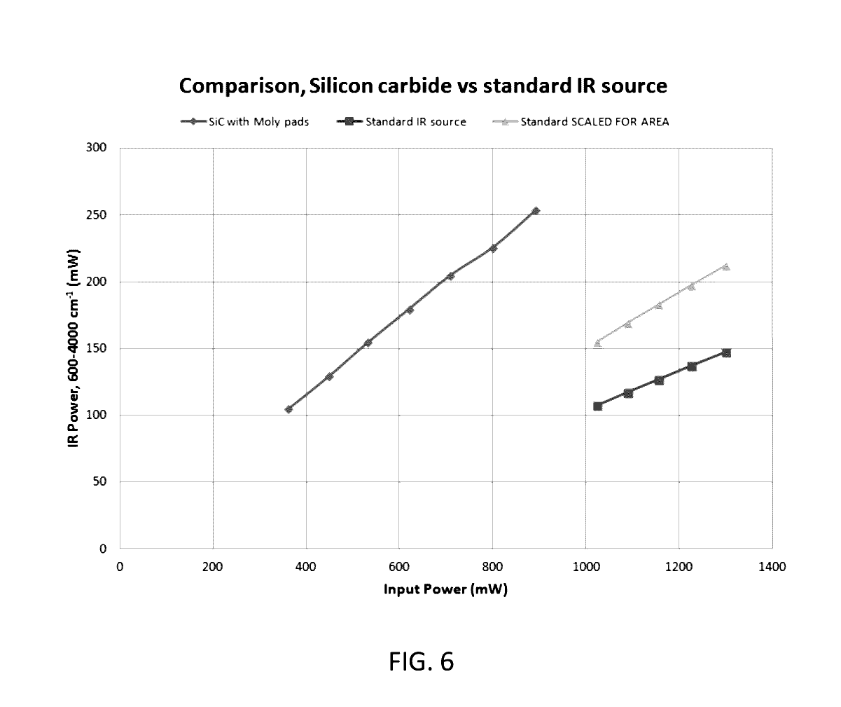

The single-crystal silicon carbide IR light sources showed significantly more IR output power than the standard IR source, as shown in FIG. 6. The single-crystal silicon carbide source had a larger area (4.16 mm²) than the standard IR source (2.89 mm²), while still being less than 10 mm² and therefore suitable for forming the limiting optical aperture of an FTIR spectrometer. For comparison purposes, however, the standard IR source was scaled up to the same area in the analysis to get a direct comparison of the emission per unit area. The data shows that the single-crystal silicon carbide source uses about half the input power to achieve the same IR output power as the standard IR source in the range of 600 cm⁻¹ to 4000 cm⁻¹, per unit emitter area. The single-crystal silicon carbide element temperature was estimated to be 822° C. at 892 mW input power, based on fitting the IR light spectrum to the spectrum of a black body. The standard IR source data was taken above the recommended operating power (not recommended for achieving long life), while the single-crystal silicon carbide source was run within its tolerable limits.

Five single-crystal silicon carbide sources were subjected to life testing for 4,000 hours. All units were power cycled with 92% duty cycle once a minute, with a power of 900 mW during the on phase. No failures were observed, indicating a probable mean time to failure of greater than 4,000 hours. With the useful operational life of a handheld instrument estimated to be about 2,000 hours, these IR light sources never have to be replaced.

### Other Embodiments

A number of embodiments have been described. Nevertheless, it will be understood that various modifications may be made without departing from the spirit and scope of the disclosure. Accordingly, other embodiments are within the scope of the following claims.

1. An infrared light source comprising:
a single-crystal ceramic element having at least two electrical contacts disposed thereon and at least two low-thermal-conductivity wires connected to the at least two electrical contacts, such that the single-crystal ceramic element is stimulated to emit infrared light upon application of an electrical current through the at least two electrical contacts; and
b) an evacuated housing enclosing the single-crystal ceramic element, the evacuated housing including an infrared-transparent window.

2. The infrared light source of claim 1, wherein the single-crystal ceramic element is a single-crystal silicon carbide element.

3. The infrared light source of claim 1, wherein the at least two electrical contacts are substantially made of molybdenum.

4. (canceled)

5. The infrared light source of claim 1, wherein the at least two low-thermal-conductivity wires are nickel-chrome wires.

6. The infrared light source of claim 1, wherein the evacuated housing includes an infrared reflector.

7. The infrared light source of claim 1, wherein the infrared transparent window is one of silicon, germanium, or zinc selenide.

8. The infrared light source of claim 1, further including a getter in the evacuated housing.

9. A method of making an infrared light source, the method comprising:
a) disposing at least two electrical contacts on a single-crystal ceramic element;
b) connecting at least two low-thermal-conductivity wires to the at least two electrical contacts.
c) enclosing the single-crystal ceramic element in a housing that includes an infrared transparent window; and
d) evacuating the housing.

10. The method of claim 9, wherein disposing the at least two electrical contacts includes brazing the contacts on the single-crystal ceramic element.

11. The method of claim 9, wherein disposing the at least two electrical contacts includes depositing a metal on the single-crystal ceramic element.

12. The method of claim 11, wherein depositing a metal includes depositing gold on the single-crystal ceramic element.

13. (canceled)

14. The method of claim 9, further including flowing a current through a getter located within the housing, after evacuating the housing.

15. The method of claim 9, further including laser heating a getter located within the housing, after evacuating the housing.

16. An FTIR spectrometer, comprising:
a) a handheld enclosure including an aperture;
b) a prism mounted in the enclosure so that a surface of the prism is exposed through the aperture;
c) an electronic display mounted in the enclosure;
d) an infrared radiation source including a single-crystal ceramic element having at least two electrical contacts disposed thereon and at least two low-thermal-conductivity wires connected to the at least two electrical contacts, and a radiation detector, the source being configured to direct radiation towards the prism and the detector being configured to detect radiation from the source reflected from the exposed surface of the prism; and
e) an electronic processor contained within the enclosure, the electronic processor being in communication with the detector, wherein the FTIR spectrometer is configured so that, during operation, the electronic processor determines an identity of a sample placed in contact with the prism and displays the identity of the sample on the electronic display.

17. The FTIR spectrometer of claim 16, wherein the single-crystal ceramic element is a single-crystal silicon carbide element.

18. The FTIR spectrometer of claim 16, further including an evacuated housing enclosing the single-crystal ceramic element, the evacuated housing including an infrared-transparent window.

19. The FTIR spectrometer of claim 16, wherein the total mass of the apparatus is less than 2 kg.
